(19) United States
(12) Patent Application Publication
(10) Pub. No.: US 2012/0212076 A1
(43) Pub. Date: Aug. 23, 2012

(54) PROTECTION CIRCUIT FOR ELECTRIC OUTLET

(76) Inventors: Yuancheng Lu, Shanghai (CN); Weibi Hong, Shanghai (CN)

(21) Appl. No.: 13/504,205

(22) PCT Filed: Nov. 15, 2010
(86) PCT No.: PCT/CN10/78743

§ 371 Date: Apr. 26, 2012

(30) Foreign Application Priority Data
Jul. 30, 2010 (CN) 201010241695.4

(51) Int. Cl. H01H 9/54; H01H 13/00

(52) U.S. Cl. 307/125

(57) ABSTRACT

A protection circuit for electric outlet includes: a switch control circuit (101), having input terminals connected to a DC power supply or an AC power supply; an automatic load detection circuit (102), having input terminals connected to the switch control circuit (101) and output terminals connected to output terminals of the outlet for detecting whether a load is connected to the output terminals of the outlet and feeding back a load signal (3) to the switch control circuit (101); and a start button (103), connected to the switch control circuit (101). The load signal (3) and the start button (103) together control whether the switch control circuit (101) should output a high-power and high-voltage AC voltage. The combined use of the automatic load detection circuit (102) and the start button (103) guarantees the safety when a child touches the outlet.

### CROSS-REFERENCE TO RELATED APPLICATION

This is a non-provisional application claiming the benefit of International Application Number PCT/CN2010/078743 filed Nov. 15, 2010.

### TECHNICAL FIELD

The present invention relates to a protection circuit for an electric outlet, and particularly relates to a protection circuit with an alternating current outlet.

### BACKGROUND ART

An AC (alternating current) outlet generally outputs a voltage of 220VAC or 110 VAC which is dangerous to the human body. Therefore, special protection measures, such as using floating power supply, fixing a protective cover over the inserting openings of an outlet, incorporating microswitches into an AC outlet, and so on, have been adopted for situations requiring a high level of safety like a vehicle-mounted AC outlet for outputting alternating voltage. Even though such protective measures are adopted, an electric shock accident might still happen when a child holds one metal chopstick, bar or the like in each hand and inserts both metal chopsticks into an AC outlet at the same time (same as inserting an electrical equipment into the outlet). At present, there is no effective countermeasure yet to prevent such accidents.

As stated above, conventional AC outlets have a problem that there is no effective measures to prevent possible electric shock accidents caused by holding in hands and inserting metal chopsticks, bars or the like, into AC outlets. Therefore, it is necessary to provide improved technical methods to solve this problem.

### SUMMARY OF THE INVENTION

In order to overcome the above-mentioned shortcoming existing in the prior art that electric shock accidents may be caused by using hands to insert metal chopsticks, bars or the like, into AC outlets, a main objective of the present invention is to provide a protection circuit for an electric outlet, which can automatically detect a load connected to an AC outlet by using an automatic load detection circuit, and co-working with the use of a start button, such that the output of high voltage AC power supply will be enabled only when a load is detected and meanwhile the start button is pressed, which guarantees the safety when a child touches the AC outlet.

To achieve the above-mentioned objective as well as other objectives, a protection circuit for an electric outlet of the present invention comprises: a switch control circuit for outputting a high-power and high-voltage AC voltage, having input terminals connected to a DC power supply or an AC power supply and output terminals connected to an automatic load detection circuit; an automatic load detection circuit, having input terminals connected to the switch control circuit and output terminals connected to output terminals of the electric outlet for detecting whether a load is connected to the output terminals of the electric outlet; and a start button, connected to the switch control circuit for generating a start-up signal; wherein the automatic load detection circuit is further connected to the switch control circuit and feeds back a load signal to the switch control circuit, the load signal and the start button working together to control whether or not the switch control circuit should output the high-voltage AC voltage.

Further, when the load signal is of high level and the start button is pressed, the switch control circuit works normally and outputs the high-power and high-voltage AC voltage; as long as the load signal exists, even when the start button is released, the high-power and high-voltage AC voltage is kept being outputted; otherwise, the switch control circuit does not output the high-power and high-voltage AC voltage.

Further, when the automatic load detection circuit detects that a load is connected to the output terminals of the electric outlet, the load signal turns to be of high level.

Further, when the input terminals of the switch control circuit are connected to a DC power supply, the switch control circuit is a DC-AC inverter.

On the other hand, when the input terminals of the switch control circuit are connected to an AC power supply, the switch control circuit at least comprises: a start-up circuit, having input terminals connected to the automatic load detection circuit and the start button for outputting a control signal by processing the load signal fed back by the automatic load detection circuit and the start-up signal; and an AC output control circuit, connected between the AC power supply and the automatic load detection circuit, and is also connected to the start-up circuit, the AC output control circuit controlling whether or not the high-power and high-voltage AC voltage should be outputted under the control of the control signal; wherein the control signal is effective and enables the output only when the load signal and the start-up signal both exist, remaining effective after the start button is released, becoming ineffective only after the load signal disappears. Further, when the load signal is of high level and the start button is pressed, the start-up circuit outputs a high level control signal, which controls the AC output control circuit to output the high-power and high-voltage AC voltage.

The AC output control circuit further comprises: an accessory power supply, serving as a power supply for the start-up circuit; a switch control transistor, having a base connected to the start-up circuit through a third resistor, a collector connected to an electrical relay, and an emitter connected to the ground; an electrical relay, connected between the switch control transistor and the accessory power supply, a coil of the electrical relay generating a current when the switch control transistor is turned on; a first resistor and a first switch, connected in parallel between a first input terminal of the AC power supply and the automatic load detection circuit; and a second resistor and a second switch, connected in parallel between a second input terminal of the AC power supply and the automatic load detection circuit, wherein, when the coil of the electrical relay generates a current, the first switch and the second switch are switched on; when there is no current within the coil of the electrical relay, the first switch and the second switch are switched off.

Further, the switch control circuit has a first output terminal and a second output terminal, wherein a first diode is connected between the first output terminal and the automatic load detection circuit, an anode of the first diode being connected to the ground and a cathode of the first diode being connected to a first output terminal of the AC output control circuit; a second diode is connected between the second output terminal and the automatic load detection circuit, an anode of the second diode being connected to the ground and a cathode of the second diode being connected to a second output terminal of the AC output control circuit.

Further, a reverse protection diode is connected to the coil of the electrical relay, an anode of the reverse protection diode being connected to the collector of the switch control transistor.

Further, a fourth resistor is connected between the base of the switch control transistor and the ground.

Further, the first resistor and the second resistor both have high resistances not lower than 110 kΩ.

Compared to the prior art, the protection circuit for electric outlet of the present invention feeds back a load signal to a switch control circuit through an automatic load detection circuit, and connects a start button to the switch control circuit, such that the switch control circuit is controlled by the load signal together with the start button to determine whether or not the switch control circuit shall work normally to output a high-power and high-voltage AC voltage. The control signal produced by the load signal and the start button becomes effective to enable the output (enables AC output) only when both of the load signal and a signal of the start button exist, and remains effective after the start button is released. The AC output becomes ineffective (disables AC output) only when the load signal disappears. AC output can not be enabled when only the start button is pressed in the absence of the load signal. Since it is impossible for a person to press the start button when both of his hands are in contact with AC output metal plates of an AC outlet, nor is it possible for a person to contact both AC outputs to generate a load signal when he is pressing the start button, therefore, the AC output can not be enabled by one person, thus guaranteeing the safety when a child touches the electric outlet.

### BRIEF DESCRIPTION OF THE DRAWINGS

FIG. 1 is a schematic view of the circuit structure of the protection circuit for electric outlet of the present invention;

FIG. 2 illustrates the circuit structure of the protection circuit for electric outlet according to a first preferred embodiment of the present invention;

FIG. 3 illustrates the circuit structure of the protection circuit for electric outlet according to a second preferred embodiment of the present invention.

### DETAILED DESCRIPTION

Embodiments of the present invention will be described below by using specific examples and drawings. Those skilled in the art will easily understand other advantages and beneficial effects of the present invention through contents disclosed by this description. The present invention can also be implemented or used in other ways, and various modifications and variations can be made to details of this description based on different views and uses, without departing from the spirit or scope of the present invention.

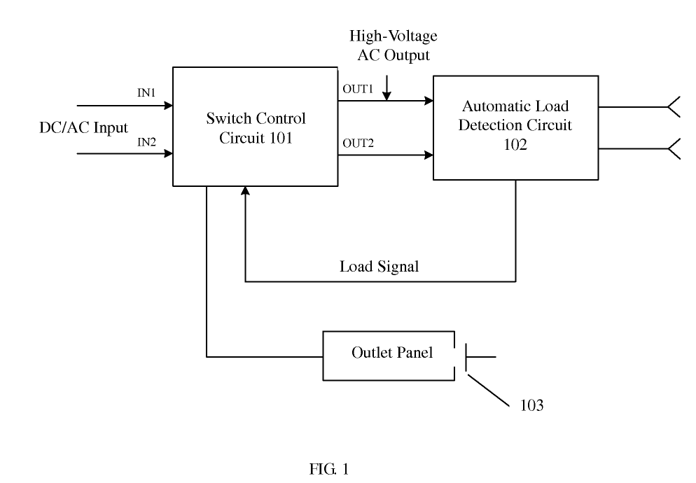

FIG. 1 illustrates the circuit structure of the protection circuit for electric outlet of the present invention. Referring to FIG. 1, the protection circuit for an electric outlet of the present invention comprises: a switch control circuit 101, which has a first input terminal IN1 and a second input terminal IN2 for connecting to a DC power supply or an AC power supply (DC/AC input), as well as a first output terminal OUT1 and a second output terminal OUT2 for connecting to an automatic load detection circuit 102; automatic load detection circuit 102, the input of which is connected to the switch control circuit 101, while the output is connected to output terminals of the electric outlet for detecting whether a load is connected to the output terminals of the electric outlet, meanwhile the automatic load detection circuit 102 is also connected to the switch control circuit 101 and feeds back a high level load signal to the switch control circuit 101 when a load is connected to the output terminals of the electric outlet, wherein a specific circuit structure of the automatic load detection circuit 102 is disclosed in Chinese patent application No. 200912058678.9, incorporated by reference, which will not be further described herein; and a start button 103, which is arranged on a panel of the electric outlet and is connected to the switch control circuit 101, wherein the switch control circuit 101 is controlled by the start button 103 together with the load signal, namely, after a DC or AC voltage is inputted into the switch control circuit 101 and being processed by the switch control circuit 101, the DC or AC voltage is controlled by the load signal together with the start button 103 to determine whether or not a high-power and high-voltage AC voltage is to be outputted to the load. More specifically, as soon as the automatic load detection circuit 102 detects that a load is connected to the output terminals of the electric outlet, the automatic load detection circuit 102 feeds back a high level load signal to the switch control circuit 101. At this time, if the start button 103 is pressed, the start button 103 will be switched on and generates a high level or low level start-up signal. The high level load signal and the start-up signal will work together to produce a control signal which controls the switch control circuit 101 to work normally, outputting a high-power and high-voltage AC voltage to the load through the automatic load detection circuit 102. That is to say, the AC output becomes effective (enables AC output) only when both of the load signal and the start-up signal exist, and remains effective after the start button is released. The AC output becomes ineffective (disables AC output) only when the load signal disappears. AC output can not be enabled when only the start button 103 is pressed in the absence of the load signal, or when only a load is connected but the start button 103 is not pressed.

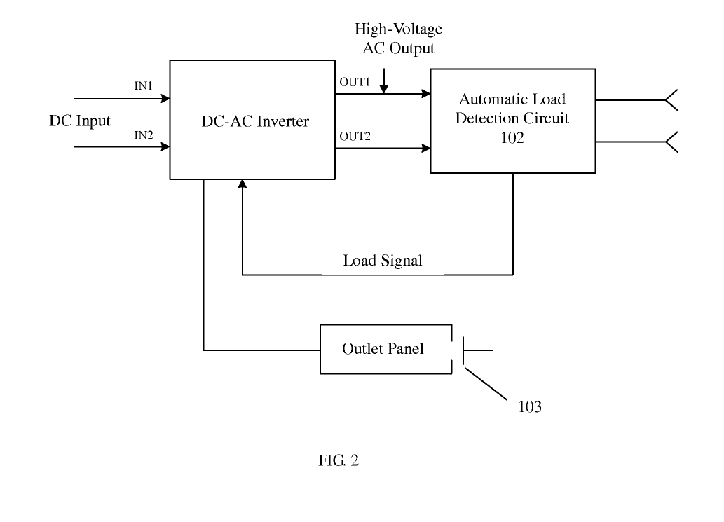

Reference will now be made in detail to a first preferred embodiment of protection circuit for electric outlet of the present invention. FIG. 2 illustrates the circuit structure of the protection circuit for electric outlet according to the first preferred embodiment of the present invention. As the protection circuit for the electric outlet of the present invention can be applied to vehicle-mounted inverters and the like, where a low DC voltage of 12V or 24V is inputted, in the first preferred embodiment, the switch control circuit 101 is a DC-AC inverter with its first input terminal IN1 and second input terminal IN2 connected to a low-voltage (e.g., 12V or 24V) DC power supply. The low DC voltage is transferred to a high AC voltage (e.g., 220V or 110V) and is outputted to a load through a first output terminal OUT1 and a second output terminal OUT2 of the DC-AC inverter. When the automatic load detection circuit 102 detects that a load is connected to the output terminals of the AC outlet of the present invention, the automatic load detection circuit 102 feeds back a high level load signal to the DC-AC inverter. At this time, if the start button 103 is pressed, a high level or low level start-up signal will be generated and transmitted to the DC-AC inverter. The high level load signal and the start-up signal work together to produce a control signal, which controls the DC-AC inverter to work normally to output a high-power and high-voltage AC voltage. The control signal becomes effective to enable the output (enables AC output) only when both of the load signal and the start-up signal exist, and remains effective after the start button 103 is released. The AC output becomes ineffective (disables AC output) only when the load signal disappears. AC output can not be enabled when only the start button 103 is pressed in the absence of the load signal, or when only the load signal exists in the absence of the start-up signal. It could be found that, the first preferred embodiment of the present invention mainly adopts the combined use of the automatic load detection circuit 102 and the start button 103, such that the DC-AC inverter works normally to output a high-power and high-voltage AC voltage only when the load signal is of high level and meanwhile the start button 103 is pressed, and keeps on working normally and effectively after the start button 103 is released. The DC-AC inverter will terminate the AC output only when the load signal disappears. AC output can not be enabled when only the start button is pressed in the absence of the load signal, or when only the load signal exists but the start button is not pressed. Since it is impossible for a person to press the start button when both of his hands are in contact with the AC output metal plates of an AC outlet (equivalent to generating a load signal), nor is it possible for a person to contact both AC outputs to generate a load signal when he is pressing the start button, therefore, the AC output can not be enabled by one person, and thus guarantees the safety when a child touches the electric outlet.

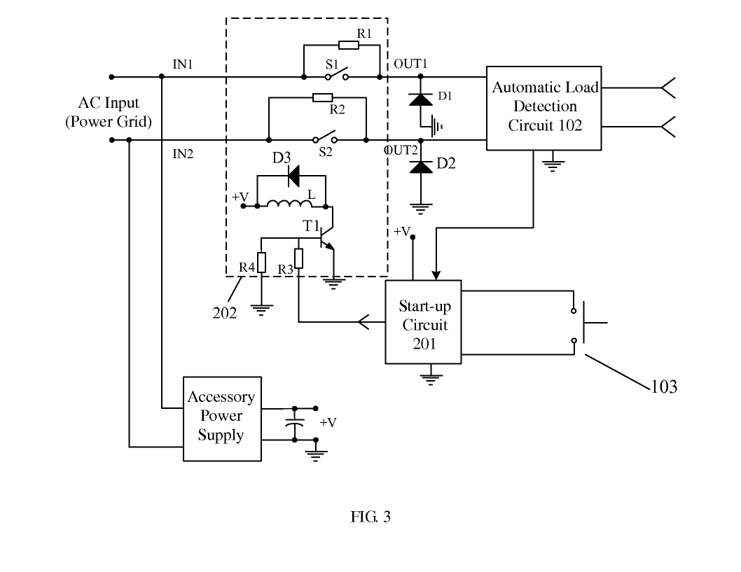

FIG. 3 illustrates the circuit structure of the protection circuit for electric outlet according to a second preferred embodiment of the present invention. The present invention will be further described below by reference to FIG. 3. Different from the first preferred embodiment of the present invention, in the second preferred embodiment of the present invention, an AC-input power supply (power grid) is connected to the first input terminal IN1 and the second input terminal IN2 of the switch control circuit 101, and correspondingly, the switch control circuit 101 further comprises: a start-up circuit 201, powered by an accessory power supply +V, wherein the start-up circuit 201 has input terminals connected to the automatic load detection circuit 102 and the start button 103, so as to receive the load signal fed back by the automatic load detection circuit 102 and the high level or low level start-up signal generated when the start button 103 is pressed, and to output a control signal by processing the load signal and the start-up signal; and an AC output control circuit 202, which is connected between the AC power supply and the automatic load detection circuit 102, and is connected to the start-up circuit 201 to receive the control signal, wherein the control signal controls whether or not the high-power and high-voltage AC voltage is to be outputted to the load.

More specifically, in the second preferred embodiment of the present invention, the AC output control circuit 202 comprises: a switch control transistor T1, the base of which is connected to the start-up circuit 201 through a third resistor R3 (a bleeder resistor) so as to receive the control signal outputted by the start-up circuit 201, the collector is connected to an electrical relay, and the emitter is connected to the ground; electrical relay, which is connected between the switch control transistor T1 and an accessory power supply +V, wherein the relay coil generates a current when the switch control transistor T1 is turned on; a first resistor R1 and a first switch S1, connected in parallel between the first input terminal IN1 and the automatic load detection circuit 102; as well as a second resistor R2 and a second switch S2, connected in parallel between the second input terminal IN2 and the automatic load detection circuit 102. When the automatic load detection circuit 102 detects that a load is connected to the output terminals of the AC outlet of the present invention, the automatic load detection circuit 102 feeds back a high level load signal to the start-up circuit 201. At this time, if the start button 103 is pressed to generate a high level or low level start-up signal, the start-up circuit 201 will be self-locked and the start-up circuit 201 will output a high level control signal. The high level control signal will turn on the switch control transistor T1, and the coil of the electric relay will generate a current. Then the first switch S1 and the second switch S2 will be switched on, and thereby outputting a high-power and high-voltage AC voltage. In this state, the AC voltage output will be maintained merely by the load signal. The start button 103 only plays a role of starting the output. When the load signal disappears, the AC output will be terminated. When there is no load connected to the output terminals of the electric outlet, or when the start button 103 is not pressed, the control signal is of low level (ineffective) and the switch control transistor T1 is cut off; no current will be generated in the electric relay; the first switch Si and the second switch S2 will be switched off and the high-power and high-voltage AC voltage will not be outputted.

In the second preferred embodiment of the present invention, the first resistor R1 and the second resistor R2 both have high resistance values. This guarantees that when initially turned on, the AC power supply produces load detection current through the first resistor R1 and the second resistor R2. The current produced will be only 1 mA or less, which is far less than the safety current for human body. An electric shock accident only occurs when an electric current passes through a human body and does harm to the body. There will be no harm if there only exists an electric voltage. An electric current less than 1 mA with a voltage of 220V will only cause a light tingling feeling in the body. Therefore, values of R1 and R2 should be designed to meet formulas:

I=VAC/(R1+R2+RL)<1mA, RL+R1+R2>VAC/I>220v/1mA=220 kΩ,

where VAC is the AC voltage and RL is the resistance of the load. Take RL=0, then we have R1=R2=110 ka Therefore, it is preferred that the resistance values of the first resistor R1 and the second resistor R2 are no lower than 110 kΩ Attention should be paid that, these resistors should meet the requirements of safety related regulations to prevent high-voltage sparking or overheated to burnout.

In the second preferred embodiment of the present invention, a first diode D1 is connected between the first output terminal OUT1 of the AC output control circuit 202 and the automatic load detection circuit 102, while a second diode D2 is connected between the second output terminal OUT2 of the AC output control circuit 202 and the automatic load detection circuit 102. The anode of the first diode D1 is connected to the ground and the cathode is connected to the first output terminal OUT1 of the AC output control circuit 202. The anode of the second diode D2 is connected to the ground and the cathode is connected to the second output terminal OUT2 of the AC output control circuit 202. By using the first diode D1 and the second diode D2, the second preferred embodiment of the present invention limits both lines of the AC power supply to have a positive electric potential compared to the ground of the start-up circuit 201, such that the automatic load detection circuit 102 can work normally.

In addition, in order to better implement the present invention, in the second preferred embodiment of the present invention, a reverse protection diode D3 is connected to the coil L of the electric relay (namely two terminals of the electric relay). The anode of the reverse protection diode D3 is connected to the collector of the switch control transistor T1 and the cathode is connected to a positive terminal of the power supply +V. A fourth resistor R4 is further connected between the base of the switch control transistor T1 and the ground. The fourth resistor R4 and the third resistor R3 constitute a bleeder circuit in order to ensure that, under the control of a start signal (a logic signal of “0” or “1”), the switch control transistor T1 works in an on or off state (turned on or cut off).

The present invention will be further described below through different working states of the second preferred embodiment of the present invention. In the second preferred embodiment of the present invention, when the electric outlet is connected to the AC power supply (AC input power grid), there will be four cases:
a: no load is connected, and the start button 103 is not pressed;
b: no load is connected, and the start button 103 is pressed;
c: a load is connected, and the start button 103 is not pressed;
d: a load is connected, and the start button 103 has been pressed (not released or has been released).

When case d arises, namely a load is connected, the automatic load detection circuit 102 will output a high level load signal to the start-up circuit 201. At this time, if the start button 103 is pressed to produce a high level or low level start-up signal, after the high level load signal and the start-up signal are processed by the start-up circuit 201, a high level control signal (which will no longer be affected by the start-up signal of the start button 103, but will be controlled by the load signal) will be outputted to the switch control transistor T1. Then the switch control transistor T1 will be turned on, and a current will be generated in the coil of the electrical relay, so that the first switch S1 and the second switch S2 are switched on. AC input from the AC power grid will be transmitted to the load through the first switch S1 and the second switch S2 with no loss. As at least one of a load signal and a start-up signal (generated when the start button is pressed) is absent in the other three cases a, b and c, the start-up circuit 201 cannot correctly send out a control signal and an AC voltage cannot be transmitted to output terminals through the first switch Si and the second switch S2 with no loss or little loss, so as to prevent electric shock accidents.

It is found that a protection circuit for an electric outlet of the present invention feeds back a load signal to a switch control circuit through an automatic load detection circuit, and connects a start button to the switch control circuit, such that the switch control circuit is controlled by the load signal together with the start button to determine whether the switch control circuit shall work to output a high-power and high-voltage AC voltage and keeps the switch control circuit to work effectively and normally after the start button is released. AC output will be terminated only after the load signal disappears. AC output can not be started when only the start button is pressed in the absence of the load signal, or when only the load signal exists but the start button is not pressed. Since it is impossible for a person to press the start button when both of his hands are in contact with the AC output metal plates of an AC outlet, nor is it possible for a person to contact both AC outputs to generate a load signal when he is pressing the start button, therefore, the AC output can not be enabled by one person, thus guaranteeing the safety when a child touches the electric outlet.

The above embodiments only illustrate the principles and beneficial effects of the present invention, but do not intend to limit the present invention. Any one of those skilled in the art can make modifications and variations to the above embodiments without departing from the spirit or scope of the present invention. Therefore, the scope of right protection of the present invention should be determined according to the scope as displayed in the claims.

What is claimed is:

1. A protection circuit for an electric outlet, comprising:
a switch control circuit for outputting a high-power and high-voltage AC voltage, having input terminals connected to a DC power supply or an AC power supply and output terminals connected to an automatic load detection circuit;
an automatic load detection circuit, having input terminals connected to the switch control circuit and output terminals connected to output terminals of the electric outlet for detecting whether a load is connected to the output terminals of the electric outlet; and
a start button, connected to the switch control circuit for generating a start-up signal;
wherein the automatic load detection circuit is further connected to the switch control circuit and feeds back a load signal to the switch control circuit, the load signal and the start button working together to control whether or not the switch control circuit should output the high-voltage AC voltage.

2. The protection circuit for an electric outlet according to claim 1, wherein when the load signal is of high level and the start button is pressed, the switch control circuit works normally and outputs the high-power and high-voltage AC voltage; as long as the load signal exists, even when the start button is released, the high-power and high-voltage AC voltage is kept being outputted; otherwise, the switch control circuit does not output the high-power and high-voltage AC voltage.

3. The protection circuit for an electric outlet according to claim 2, wherein when the automatic load detection circuit detects that a load is connected to the output terminals of the electric outlet, the load signal turns to be of high level.

4. The protection circuit for an electric outlet according to claim 3, wherein when the input terminals of the switch control circuit are connected to a DC power supply, the switch control circuit is a DC-AC inverter.

5. The protection circuit for an electric outlet according to claim 3, wherein when the input terminals of the switch control circuit are connected to an AC power supply, the switch control circuit at least comprises:
a start-up circuit, having input terminals connected to the automatic load detection circuit and the start button for outputting a control signal by processing the load signal fed back by the automatic load detection circuit and the start-up signal; and
an AC output control circuit, connected between the AC power supply and the automatic load detection circuit, and is also connected to the start-up circuit, the AC output control circuit controlling whether or not the high-power and high-voltage AC voltage should be outputted under the control of the control signal;
wherein the control signal is effective and enables the output only when the load signal and the start-up signal both exist, remaining effective after the start button is released, becoming ineffective only after the load signal disappears.

6. The protection circuit for an electric outlet according to claim 5, wherein when the load signal is of high level and the start button is pressed, the start-up circuit outputs a high level control signal, which controls the AC output control circuit to output the high-power and high-voltage AC voltage.

7. The protection circuit for an electric outlet according to claim 6, wherein the AC output control circuit further comprises:
an accessory power supply, serving as a power supply for the start-up circuit;
a switch control transistor, having a base connected to the start-up circuit through a third resistor, a collector connected to an electrical relay, and an emitter connected to the ground;
an electrical relay, connected between the switch control transistor and the accessory power supply, a coil of the electrical relay generating a current when the switch control transistor is turned on;
a first resistor and a first switch, connected in parallel between a first input terminal of the AC power supply and the automatic load detection circuit; and
a second resistor and a second switch, connected in parallel between a second input terminal of the AC power supply and the automatic load detection circuit,
wherein, when the coil of the electrical relay generates a current, the first switch and the second switch are switched on; when there is no current within the coil of the electrical relay, the first switch and the second switch are switched off.

8. The protection circuit for an electric outlet according to claim 7, wherein the switch control circuit has a first output terminal and a second output terminal, wherein a first diode is connected between the first output terminal and the automatic load detection circuit, an anode of the first diode being connected to the ground and a cathode of the first diode being connected to a first output terminal of the AC output control circuit; a second diode is connected between the second output terminal and the automatic load detection circuit, an anode of the second diode being connected to the ground and a cathode of the second diode being connected to a second output terminal of the AC output control circuit.

9. The protection circuit for an electric outlet according to claim 8, wherein a reverse protection diode is connected to the coil of the electrical relay, an anode of the reverse protection diode being connected to the collector of the switch control transistor.

10. The protection circuit for an electric outlet according to claim 9, wherein a fourth resistor is connected between the base of the switch control transistor and the ground.

11. The protection circuit for an electric outlet according to claim 10, wherein the first resistor and the second resistor both have high resistances not lower than 110 kΩ.
